(19) United States
(12) Patent Application Publication
(10) Pub. No.: US 2013/0222574 A1
(43) Pub. Date: Aug. 29, 2013

(54) DEFECT CLASSIFICATION SYSTEM AND DEFECT CLASSIFICATION DEVICE AND IMAGING DEVICE

(71) Applicants: Ryo Nakagaki, Kawasaki (JP); Minoru Harada, Fujisawa (JP); Takehiro Hirai, Ushiku (JP)

(72) Inventors: Ryo Nakagaki, Kawasaki (JP); Minoru Harada, Fujisawa (JP); Takehiro Hirai, Ushiku (JP)

(21) Appl. No.: 13/878,256

(22) PCT Filed: Oct. 3, 2011
(86) PCT No.: PCT/JP2011/005565

§ 371 Date: May 9, 2013

(30) Foreign Application Priority Data
Oct. 8, 2010 (JP) 2010 228078

(51) Int. Cl. G06T 7/00

(52) U.S. Cl. CPC G06T 7/0004
USPC 348/125

(57) ABSTRACT

In a defect classification system using plural types of observation devices that acquire images having different characteristics, classification performance and operability of the system are improved. The a defect classification system includes plural imaging part that acquire images of an inspection target, a defect classification device that classifies the acquired images acquired by the plural imaging part, and a communication part that transmits data between the plural imaging devices and the defect classification device, in which the defect classification device includes an image storage part that stores the acquired image data acquired by the plural imaging part, an information storage part that stores associated information about the input image data, and a part for changing a processing method or a display method depending on the associated information.

### TECHNICAL FIELD

The present invention relates to a defect classification system and a defect classification device and an imaging device that classify various defects generated in a manufacturing process of semiconductor wafers and the like.

### BACKGROUND

In the manufacture of semiconductor wafers, rapid launch of the manufacture process and production of the wafers in a mass scale in high yield are important for assuring a profit. For this purpose, a wafer inspection system made of a defect inspection device and a defect observation device has been introduced in manufacturing lines. In the wafer inspection system, the defect inspection device detects defects on wafers and thereafter the defect observation device observes and analyzes the defects. Consequently, the wafer inspection system takes measures based on the result. Generally, an optical wafer inspection device or an electron-beam wafer inspection device is used as the defect inspection device. For example, Japanese Unexamined Patent Application Publication No. 2000-97869 discloses a technique in which an optical image of the surface of a wafer is acquired using bright field illumination and defects are inspected by comparing the optical image with an image of a good product site (for example, an image of an adjacent chip). However, the optical wafer inspection device described above is affected by illumination wavelength, and thus resolution limit of the acquired image is about several hundred nanometers. Consequently, the optical wafer inspection device can only detect presence or absence of detects on wafers having a size of several tens of nanometers, and cannot analyze the defects in detail. A device for analyzing the defects in detail is a defect observation device. An electron beam observation device (a review SEM (Scanning Electron Microscope)) is used in manufacturing sites because defects having a size of several tens of nanometers are required to be observed. For example, Japanese Unexamined Patent Application Publication No. 2001-135692 discloses a review SEM and an Automatic Defect Review (ADR) function and an Automatic Defect Classification (ADC) function that are incorporated in the review SEM. The ADR function is a function that automatically acquires an SEM image of the site using position information on the wafer where defects are detected by the wafer inspection device as an input. The ADC function is a function in which the acquired defect image is automatically classified into plural defect classes defined from the viewpoint of a cause of defects.

### SUMMARY

The ADC function described above is a function in which various characteristics such as a size and a shape of the defect site is calculated as characteristic amount from the acquired SEM image and the defects are classified into plural predefined defect classes based on the calculated characteristic amount. Nowadays, the review SEM's are commercialized by several manufacturers. Each of the manufacturers provides the ADC function incorporated in a defect classification device that is sold together with the review SEM of each manufacturer. The defect classification device has not only an automatic classification function of the defect image described above, but also a display function that displays the classification result to users; a function that corrects the automatic classification result by accepting inputs from the users; and a function that transfers the classification result to, for example, a database server for yield management installed at a manufacturing line.

In the yield management operation in semiconductor device manufacturing, use of plural different types of inspection devices and observation devices are frequently occurs. For this reason, ensuring reliability of the inspection process is exemplified. When performance is different in each device, reliability of the inspection operation can be improved by using each device in a complementary manner. In some cases, plural different types of inspection devices must be used because a time of purchase of a device and a time of supply of the device from the device manufacturer are not matched. Here, the different types of devices include devices produced by different manufacturers and different types of devices produced by the same manufacturer.

Different types of devices frequently provide different functions and characteristics. Consequently, effective use of such devices having different functions and characteristics is required for the yield management operation. This requirement is also requested for the review SEM and the defect classification device associated with the review SEM. In other words, the defect classification device and system that classify images acquired by different types of review SEM's has a high level of needs.

Each defect classification device according to a related art, which is a system associated with the specific defect observation device (here, the review SEM), does not assume images acquired by different types of defect observation devices as the processing targets. As a result, development of a defect classification system that uses the defect classification devices according to the related art and determines the images acquired by different types of defect observation devices to be processing targets raises the following problem.

The first problem is insufficient classification performance. A processing algorithm installed in a defect classification processing is designed in accordance with characteristics of image data that a defect observation device corresponding to the defect classification device outputs. However, different types of defect observation devices frequently provide differences in the number of detected images and characteristics of each image. This is because, although the review SEM detects secondary electrons and backscattered electrons generated from a wafer surface, each device provides difference in the number of detectors for detecting these electrons, a detection direction of each detector, detection yield, and a degree of separation of the secondary electrons and the backscattered electrons in each detector. Input of image data having different characteristics from the image data that is assumption data at the time of designing the processing algorithm into the defect classification device may cause deterioration in the classification performance in high possibility.

The second problem is deterioration in operability. As described above, the defect classification device is provided with a display function that displays defect images and classification results of the defect images and a correction function that corrects the classification result. However, display of the defect images acquired by the devices having different characteristics of the detector on the display screen may cause significantly difference in viewpoint and interpretation to each image. In this case, the user operability may deteriorate.

Aspects of the representative inventions disclosed in this application are simply described as follows.

(1) A first aspect is a defect classification device that classifies plural images of a defect on a sample surface that is an inspection target acquired by plural imaging devices, the defect classification device including: an image storage part that stores plural images acquired by the plural imaging devices; an associated information storage part that stores associated information associated with each of the plural images, the associated information including at least one of information that specifies a type of the plural imaging devices that acquire each of the plural images or information of detection conditions at the time of acquiring the plural images; an image processing part that processes a part of or the all of the plural images so that the plural images resemble each other based on the associated information stored in the associated information storage part; and a classification part that classifies the plural images based on the plural images processed by the image processing part.

(2) A second aspect is a defect classification device that classifies plural images of a defect on a sample surface that is an inspection target acquired by plural imaging devices, the defect classification device including: an image storage part that stores image data of each defect site inputted from the imaging devices into the defect classification device; an associated image storage part that stores associated information including information that specifies a type of imaging device that acquire each image data or information of detection conditions of the acquired image data; an image processing part that classifies the images; and a display part that displays the classification result, in which processing contents in the image processing part and display contents in the displaying part are changed depending on the associated information stored in the associated information storage part.

(3) A third aspect is an imaging device that acquires an image of a defect on a sample surface that is an inspection target, the device including: an electron beam irradiation part that irradiates a sample surface with an electron beam based on previously obtained defect position information; an imaging part that acquires plural images in a manner that secondary electrons or backscattered electrons generated from the sample surface by irradiation with an electron beam by the electron beam irradiation part are detected by plural detectors; an associated information generation part that generates associated information associated with each of the plural images and having information of detection conditions at the time of acquiring the plural images; and an image processing part that processes a part of or the all of the plural images so that the plural images resemble each other based on the associated information generated by the associated information generation part.

(4) A fourth aspect is a defect classification system including: plural imaging devices that acquire images of a defect on a sample surface that is an inspection target a defect classification device comprising an image storage part that stores plural images acquired by the plural imaging devices, an associated information storage part that stores associated information associated with each of the plural images, the associated information comprising at least one of information that specifies a type of the plural imaging devices that acquire each of the plural images or information of detection conditions at the time of acquiring the plural images; and an image processing part that processes a part of or the all of the plural images so that the plural images resemble each other based on the associated information stored in the associated information storage part, in which the defect classification device further comprises a classification processing part that classifies the plural images based on the plural images processed by the image processing part.

According to the aspects of the present invention, a defect classification system that classifies defect image data acquired by plural imaging devices having different image detection characteristics in high performance and improving operability, and a defect classification device and an imaging device that constitute the defect classification system.

### BRIEF DESCRIPTION OF THE DRAWINGS

FIG. 1 is a configuration diagram of one embodiment of a defect classification system;

FIG. 2 is a configuration diagram of the one embodiment of an imaging device;

FIGS. 3A, 3B, and 3C are examples of acquisition images acquired by the imaging device: FIG. 3A is a top image; and FIG. 3B is a left image; and FIG. 3C is a right image;

FIG. 4 are views illustrating location examples of defect cross sections and detectors: FIG. 4A is a view in the case that a defect is convex; and FIG. 4B is a view in the case that a defect is concave;

FIGS. 5A, 5B, and 5C are schematic views illustrating location of the detectors and detected shade directions of acquired images: FIG. 5A is a schematic view illustrating an example in which detectors are arranged in an x direction; FIG. 5B is a schematic view illustrating an example in which both detectors are rotated at 45° in a clockwise direction to FIG. 5A; and FIG. 5C is a schematic view illustrating an example in which both detectors are rotated at 45° in an anti-clockwise direction to FIG. 5A;

FIG. 6 are examples of shade detection images acquired by the imaging device: FIG. 6A-i is an image of a convex defect acquired by a detector 204; FIG. 6A-i is an image of a convex defect acquired by a detector 205; FIG. 6B-i is an image of a concave defect acquired by the detector 204; and 6B-i is an image of a concave defect acquired by the detector 205;

FIG. 7 is a flowchart showing a processing procedure in a defect classification device;

FIG. 8 is a table showing one example of a data set list;

FIG. 9 is a table showing an example of associated information associated with the defect image;

FIG. 10 is a table showing one example of the associated information in a table format;

FIG. 11 is a view illustrating a list of the acquired images and images after image processing;

FIG. 12 is a view illustrating an example of a display screen of a classification result;

FIG. 13 is a configuration diagram illustrating a defect classification device in a second embodiment;

FIG. 14 is a table showing one example of displayed images and information that defines conditions of the displayed images;

FIGS. 15A, 15B, and 15C are views illustrating examples of display screen of plural defect images having different detection direction: FIG. 15A is a view illustrating acquired images; FIG. 15B is a view illustrating processed images; and FIG. 15C is a view illustrating images having arrows that indicate direction of detectors; and

FIG. 16 is a configuration diagram illustrating an imaging device in a third embodiment.

### DETAILED DESCRIPTION

Hereinafter, embodiments of the present invention will be described using the drawings.

### First Embodiment

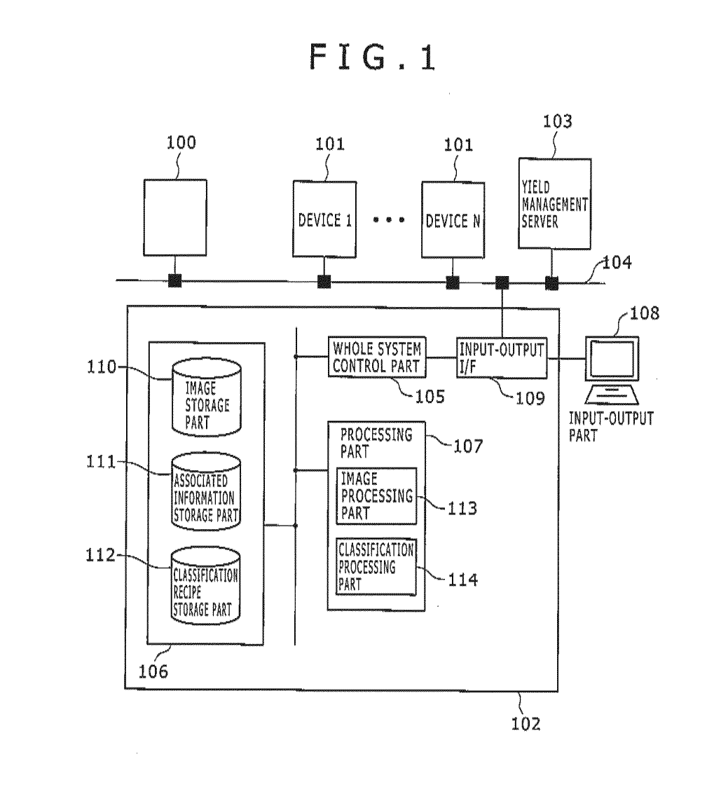

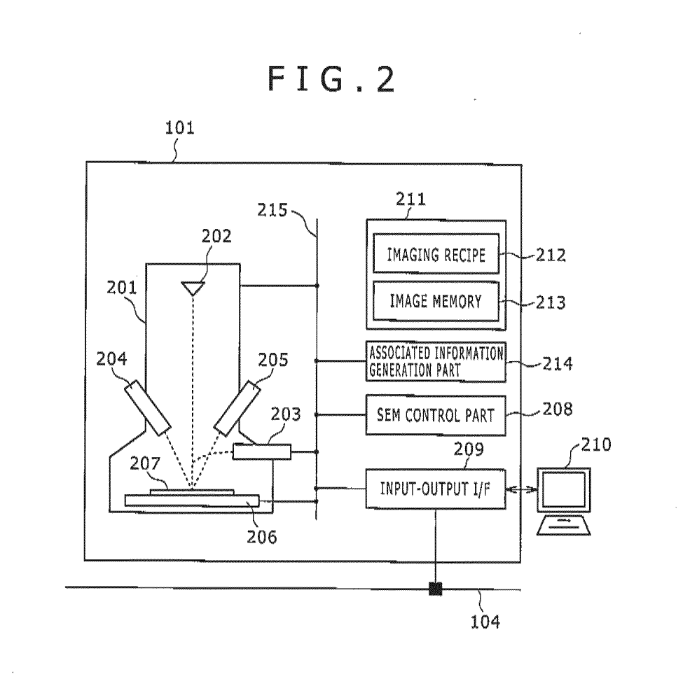

FIG. 1 illustrates a configuration diagram of one embodiment of a defect classification system. The system is configured in a manner that a wafer inspection device 100, imaging devices 101, a yield management server 103, and a defect classification device 102 are connected through a communication part 104. The wafer inspection device 100 inspects wafers in the manufacturing stage of semiconductor devices and outputs position information of the defect site of the detected wafer. The imaging device 101 acquires coordinate information of the defect site obtained from the wafer inspection device 100 and acquires images including the defect site based on the coordinate information of the defect site. In FIG. 1, an example in which n imaging devices 101 exist in this system is illustrated. Details of the imaging device 101 will be described later using FIG. 2. The yield management server 103 has a function that manages various data for managing yield in a manufacturing line. Specifically, the yield management server 103 manages data such as the number of defects in each wafer, a coordinate value of each defect, images of each defect acquired by the imaging devices 101, and a classification result of each defect. The defect classification device 102 has functions that classify defect images acquired by the imaging devices 101 and transmit the result to the yield management server 103. Details of the defect classification device 102 will be described below.

The a defect classification device 102 is configured by adequately using a whole system control part 105 that controls operations of each device, a storage part 106 that stores the acquired images, associated information acquired from the imaging device together with the images, and classification recipes being processing condition setting files required for the classification processing, a processing part 107 that executes the image processing and the classification processing to the acquired images, an input-output part 108 configured by a keyboard, a mouse, and a display for displaying the data to an operator and receiving inputs from the operator, and an input-output I/F 109 for data transfer through the communication part 104. The storage part 106 further includes an image storage part 110 that stores the acquired images, an associated information storage part 111 that stores associate information that is acquired by the imaging device together with the images, and a classification recipe storage part 112 that stores classification recipes. The processing part 107 includes an image processing part 113 that processes the images and a classification processing part 114 that classifies the images and the processed images. Both parts are described below in detail.

Detailed configuration example of the imaging device 101 will be described using FIG. 2. The imaging device 101 is configured by an SEM body 201, an SEM control part 208, an input-output I/F 209, a storage part 211, and an associate information generation part 214 that are connected through a communication part 215. The input-output I/F 209 is connected to the communication part 104 and an input-output part 210 and performs input and output of data to the operator through the input-output part 210.

The SEM body 201 is configured by adequately using a stage 206 on which a sample wafer 207 is mounted, an electron source 202 that irradiate the sample wafer 207 with first electron beams, and plural detectors 203, 204, 205 that detect secondary electrons and backscattered electrons generated by the irradiation of the first electron beams to the sample wafer 207 by the electron source 202. Although not illustrated, the SEM body 201 is also configured by adequately using a deflector for scanning the first electron beams to an observation region of the sample wafer 207, and an image generation part that generates a digital image by digitally converting intensity of detected electrons.

The storage part 211 is configured by adequately using an imaging recipe storage part 212 that stores an acceleration voltage, a probe current, the number of added frames (the number of images used for a processing to reduce an effect of shot noise by acquiring several images at the same place and generating an average image of the several images), and a size of a microscopic field that are SEM imaging conditions, and an image memory 213 that stores acquired image data.

The associated information generation part 214 has a function that generates information associated with each image data such as ID information that specifies imaging conditions and an imaging devices of the image data, and information of a type and properties of each of the detectors 203-205 used for image generation. The associated information generated by the associated information generation part 214 is transferred with its image data when the image data is transferred through the input-output I/F 209.

The SEM control part 208 controls processing processed in the imaging device 101 such as imaging. By instructions from the SEM control part 208, movement of the stage 206 in order to place the predetermined observation site on the sample wafer 207 into the imaging field, irradiation of the first electron beam to the sample wafer 207, detection of electrons generated from the sample by the detectors 203-205, image generation from the detected electrons and storage of the generated image into the image memory 213, generation of associated information of the acquired image in the associate information generation part 214, and the like are performed. Various instructions and specification of imaging conditions from the operator is performed through the input-output part 210 configured by a keyboard, a mouse, a display, and the like.

The imaging device 101 incorporates the Automatic Defect Review function (ADR function) of defect images disclosed in Japanese Unexamined Patent Application Publication No. 2001-135692. The ADR function is a function that SEM images at the site are automatically collected by using information of defect positions on the sample wafer 207 as an input. In the ADR, acquisition of an image of the defect site is frequently performed in two stages, that is, [1] an image having a sufficiently wide microscopic field (for example, several micrometers) and including a coordinate position of a defect is acquired and the defect position is identified from the image by image processing, and [2] the image of the defect is acquired in the specified narrow microscopic field (for example, 0.5 micrometers). This is because direct imaging of the defect site in high magnification frequently results in absence of the defect in the microscopic field, because accuracy in the stop position of the stage 206 and accuracy of the coordinate position of the defect that is outputted by the wafer inspection device 100 are insufficient compared with a size of the microscopic field of the acquired defect image in high magnification (that is, a narrow microscopic field). Hereinafter, at the time of two-stage acquisition of images as described above, an image obtained in [1] is referred to as a “low magnification image” and image obtained in [2] is referred to as a “high magnification image”.

The image collection processing by ADR is executed for plural defects on the wafer (all detected defects or plural sampled defects), and the acquired images are stored in the image memory 213. The sequence of the processing described above is executed by the SEM control part 208.

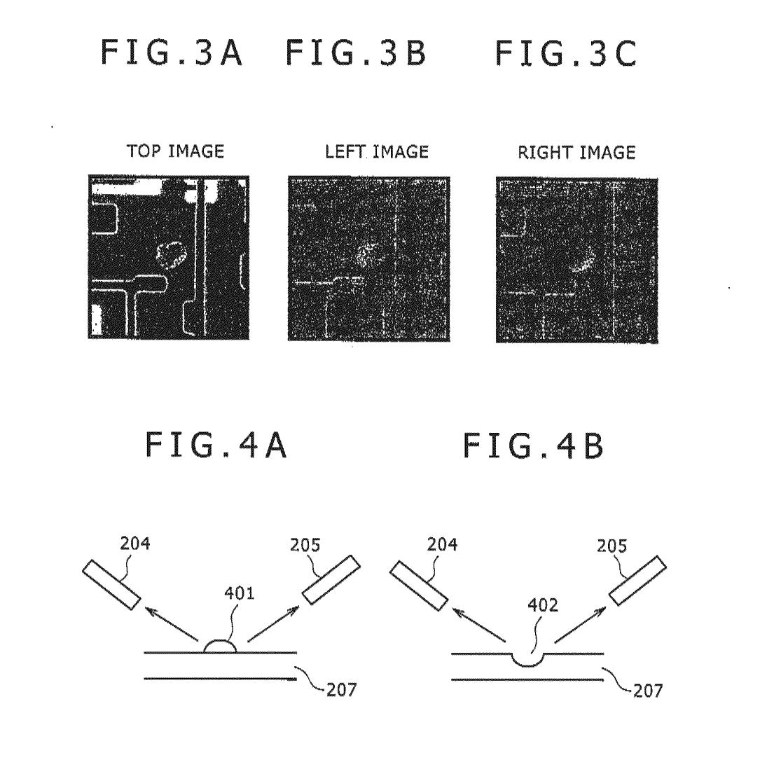

One embodiment of the imaging device 101 illustrated in FIG. 2 has three detectors. Consequently, the imaging device 101 can simultaneously acquire three images of the observation site on a wafer. FIG. 3 is an example of three acquired images of a foreign substance on the surface of a wafer. FIG. 3A is the image acquired by detecting secondary electrons generated from the sample by the detector 203. FIGS. 3B and 3C are the images acquired by detecting backscattered electrons generated from the sample by the two detectors 204, 205, respectively. Here, the image of FIG. 3A acquired by the detector 203 is referred to as a top image, and the images of FIGS. 3B and 3C acquired by the detectors 204, 205 are referred to as a left image and a right image, respectively. In the top image of FIG. 3A, profiles of a circuit pattern and defect site can clearly be observed compared with the other images. On the other hand, in the left image and the right image of FIGS. 3B and 3C, the shades generated due to a concave/convex state of the surface can be observed. Difference in image characteristics as described above is caused by locations of the detectors, energy bands of detected electrons that the detectors have, an electromagnetic field provided in a column that affects orbitals of electrons generated from the sample, and the like. In addition, image quality varies depending on imaging conditions, for example, an acceleration voltage of electrons, an amount of a probe current, the number of added frames, and the like.

Here, as an example in which characteristics of acquired images are different due to differences in characteristics of the detectors, a relation between directions of the detectors 204, 205 for backscattered electrons and the shade of the image using FIGS. 4A to 6B. Positional relations between cross-section surfaces of the samples and the detectors 204, 205 for backscattered electrons are schematically illustrated in FIG. 4A in which a convex defect 401 exists on the sample wafer 207 and FIG. 4B in which a concave defect 402 exists on the sample wafer 207. In this embodiment, two detectors 204, 205 for backscattered electron are arranged obliquely upward to the sample wafer 207 in an opposed position as illustrated in FIGS. 4A and 4B. The sample is irradiated with first electron beam from right above. The backscattered electrons generated from the observation site, which has characteristics that the backscattered electrons has high energy and orientation, the backscattered electrons generated in a direction of one of the detectors rarely reach to the other detector placed in the opposite side. As a result, the image in which the shade corresponding to the concave/convex state of the observation site can be observed can be acquired as illustrated in FIGS. 3B and 3C.

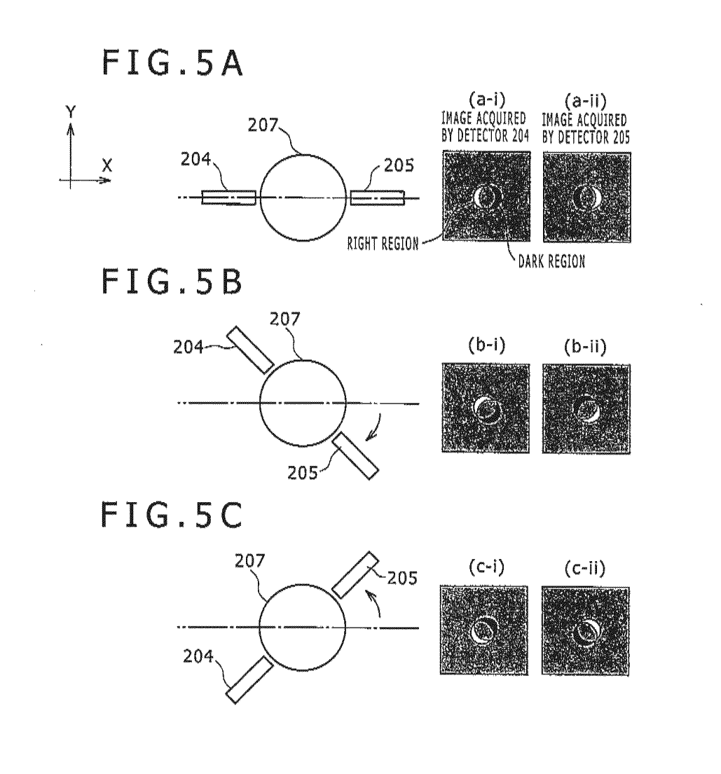

The direction of the shade varies when a relative position of the detectors 204, 205 to the sample wafer 207 varies. FIGS. 5A to 5C are views schematically illustrating directions of the detectors and directions of the shade of the acquired images. Each of the images (i) and (ii) schematically illustrates the images acquired by the detectors 204 and 205, respectively. FIG. 5A is an example that the detectors are aligned in the X direction in the coordination system. In FIG. 5A, positions of a bright region and a dark region in the images (a-i) and (a-ii) acquired by the detectors 204, 205, respectively, are as illustrated in the images (a-i) and (a-ii). As a result, shade is generated in the X direction. Here, the bright region is a region having high brightness in this image. The bright region means that many of the backscattered electrons generated at the site are detected by the detector, whereas the dark region means that few of the backscattered electrons generated at the site are detected by the detector. The reason why the brightness and the darkness emerge as described above is because backscattered electrons have orientations and thus the brightness and the darkness in the image are determined depending on the generation direction of the backscattered electrons in each site and the position and the direction of the detector that detects the backscattered electrons. FIG. 5B is a view in which directions of both detectors are rotated clockwise at 45° to FIG. 5A. The direction of the shade is also rotated to FIG. 5A. Similarly, FIG. 5C is a view in which both detectors are placed in the position where both detectors are rotated counterclockwise at 45° to FIG. 5A. Similarly, the direction of the shade is also rotated in FIG. 5C. As described above, the direction of the shade varies when the direction of the detector varies.

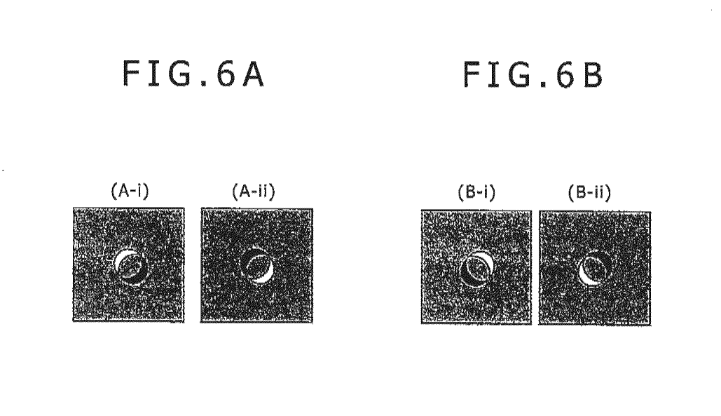

On the other hand, it should be noted that the direction of the shade also varies depending on a concave/convex state of the target. In other words, it should be noted that the directions of the shades become opposite in the convex defect and the concave defect illustrated in FIGS. 4A and 4B, respectively. Consequently, for example, whether the defect of the observation target is convex or concave cannot be determined without information of a configuration of the detectors, when each image is acquired by the detectors 204, 205 as illustrated in FIGS. 6A and 6B. In this example, as a matter of fact, the images of (A-i) and (A-ii) in FIG. 6A are images of the convex defect acquired by the detectors 204, 205, respectively, that are configured as illustrated in FIG. 5B, and the images of (B-i) and (B-ii) in FIG. 6B are images of the concave defect acquired by the detectors 204, 205 respectively that are configured as illustrated in FIG. 5C. As described above processing or displaying mixed images acquired by detectors having different configuration may cause improper recognition of concavo-convex relation in the defect site.

The plural imaging devices 101 are connected in the defect classification system of this embodiment illustrated in FIG. 1. However, types of the imaging devices may be different from each other. For example, the devices may be provided from different manufacturers or plural products whose configuration of detectors is different may be provided even when the manufacturer is the same. So far, the example in which the number of the detectors of the imaging device is three and the relative positional relation of the detectors to the sample varies when the detectors for detecting the backscattered electrons are placed in the opposed position is described. However, other conditions such as the numbers of the detectors, directions and the relative position relation of each detector, and energy bands of the detected electrons are possibly different in each device. In addition, generated energy from the sample may vary depending on conditions at the time of imaging. Consequently, is should be noted that the acquired images may also vary depending on these conditions.

Subsequently, operation of the defect classification system using the defect classification device 102 and the imaging devices 101 illustrated in FIG. 1 will be specifically described.

Here, the processing in the defect classification device 102 and the processing in the wafer inspection device 100 and the imaging devices 101 should be asynchronously performed. More specifically, inspection of the sample wafer by the wafer inspection device 100, imaging of the detect site by the imaging device 101, and transfer of the acquired data to the defect classification device 102 are asynchronously performed to the processing in the defect classification device 102 as described below.

These asynchronous processings will be specifically described. First, the inspection target wafer 207 is inspected by the wafer inspection device 100. Subsequently, the wafer 207 is sent to an imaging device that is not used at the time in the imaging devices 101 that are plurally installed, and then an image data set of the defect site that is detected by the wafer inspection device is acquired by the ADR processing in the imaging device in which the wafer 207 is placed. The acquired image data set is transmitted to the defect classification device 102 through the communication part 104 and stored in the image storage part 110 in the storage part 106. At the time of transfer of the image data set, the associate information generated in the associate information generation part 214 in each imaging device 101 is also transferred and stored in the associated information storage part 111 in the storage part 106. Examples of the associated information adequately include ID for specifying the device that acquires the image and attribute information of each image such as information identifying whether the magnification is low or high, information identifying which image is selected from plural detected images, and information of an acceleration voltage, a probe current, and the number of added frames at the time of the imaging.

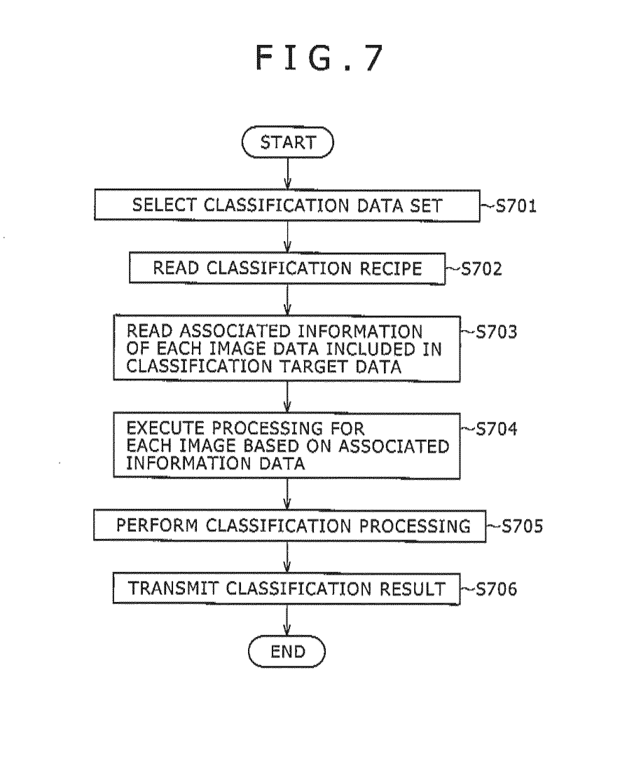

Processing procedure executed in the defect classification device 102 will be described using the flowchart of FIG. 7. First, an image data set for which the classification processing is executed is selected (S701). The data set to these data is selected as described below. The image data set is asynchronously transferred to the defect classification device 102 when every ADR processing is executed in the plural imaging devices 101. The defect classification device 102 updates a list of the received data sets in every reception of data set. Thereafter, the whole system control part 105 refers the list in a constant time interval and the earliest received data is sequentially determined as the classification target data set when data sets for which the classification processing is not completed exist.

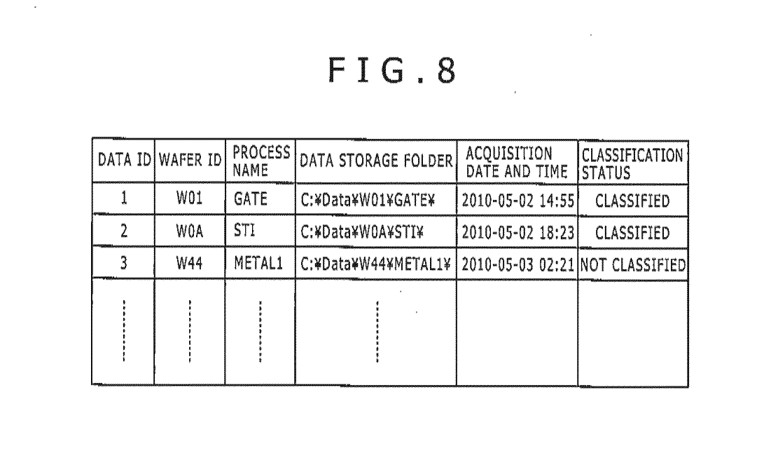

FIG. 8 illustrates one example of the data set list. For example, a wafer ID, a process name, a data storage folder, data acquisition time and date, and a classification status (classified or not classified), other than the data ID that specifies the data set, are attached to each data set and the data sets are managed in the form of a table. This information is stored in the image storage part 110 together with the image data, and automatically updated when every data is transferred. By displaying the data list on the screen of the input-output part 108, the operator can check the list shown in FIG. 8 in the screen of the input-output part 108 and can start the classification processing by manually specifying data sets that are not classified.

Subsequently, the classification recipe being a parameter set of the process performed in the processing part 107 is read from the classification recipe storage part 112 (S702). For the selected data set, the associated information corresponding to the image data included in the data set is read from the associated information storage part 111 (S703), and each associated information is transmitted to the processing part 107.

Thereafter, based on the read associated information, the image processing corresponding each image data is executed in the image processing part 113 (S704). As described above, the associated information adequately includes the ID for specifying the device that acquires the image and the attribute information of each image such as the information identifying whether the magnification is low or high, the information identifying which image is selected from the plural detected images, and the information of the acceleration voltage, the probe current, and the number of added frames at the time of the imaging.

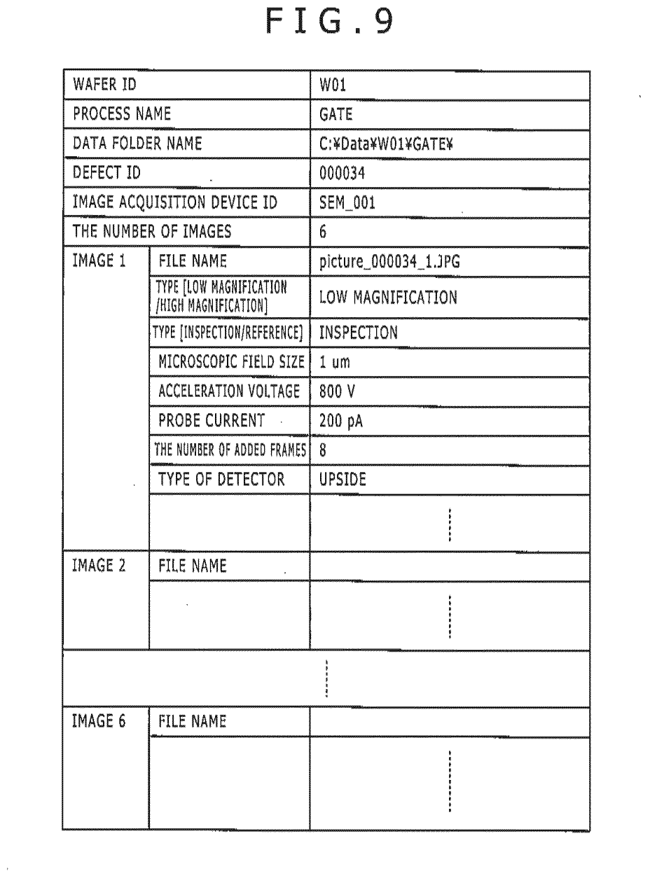

FIG. 9 is one example showing the associated information stored in the associated information storage part 111 in the form of a table. The operator can check the associated information by displaying the associated information shown in FIG. 9 on the screen of the input-output part 108. Examples of the attribute item in the associated information include a wafer ID, a process name, a data folder name, a defect ID, an imaging device ID, and the number of images. The attributes with relation to each image data are stored corresponding to the number of the images. As the attributes provided for each image data, a data file name, information identifying whether the image is a high magnification image or a low magnification image, information identifying whether the image is an inspection image or a reference image, a microscopic field size, and information of the acceleration voltage, the probe current, the number of added frames, and the type of a detector (upside, right side, or left side) at the time of the imaging are adequately used.

Subsequently, the image processing executed in the image processing part 113 will be described in detail by referring the associated information. The image processing part a series of processes in which an image data set is determined as an input and an image data set in which the input is processed is outputted. Specifically, an image improvement processing, a shade direction conversion processing, an image mixing processing, and the like are adequately executed.

Examples of the image improvement processing include a noise reduction processing. In SEM, an image having a low S/N ratio tends to be acquired when a probe current at the time of the imaging is low or when the number of added frames is low. Even when imaging conditions are the same, a different imaging device may provide an image having a different S/N ratio due to difference in electron detection yield in the detector. Even when the same type device is used, difference in S/N ratios may be generated due to difference in performance between devices, if a degree of adjustment is different. Specific examples of the noise reduction processing include various types of noise filter processes.

Another example of the image improvement processing includes a sharpness conversion processing for reducing deference in sharpness caused by an image blur due to a beam diameter of the first electron beam. In SEM, an observation site is scanned by an electron beam focused in a diameter of several nanometers. This beam diameter affects sharpness in an image. In other words, a thick beam generates a blur, and thus, an image having reduced sharpness is acquired. Consequently, plural devices having different focusing performance of the first electron beam provide images having different sharpness. A deconvolution processing is effective in order to acquire an image having higher sharpness from the acquired image, whereas a low-pass filter is effective in order to acquire an image having lower sharpness from the acquired image.

Another example of the image improvement processing includes a contrast conversion processing. This processing includes a processing that removes brightness change when the screen brightness is gradually changed in the whole observation filed caused by a charging phenomenon on the sample surface, and a processing in which an image having high visibility is acquired by correcting the brightness in a circuit pattern part and the defect site. In SEM, the brightness-darkness relation in the circuit pattern part and the non-pattern part may be inverted when the imaging condition are different and when the imaging devices are different even using the same imaging conditions. This contrast conversion processing can unify appearance of the images acquired by different devices or in different conditions by correcting the inverted brightness as described above.

Another example of the image processing includes a shade information conversion processing. As illustrated in FIGS. 5A to 5C, for example, shade information acquired by detecting backscattered electrons is extremely affected by arrangement form of the detectors in the device. As illustrated in FIGS. 6A and 6B, when different images acquired by the detectors having different arrangement form exist in a mixed manner, improper determination of a concave/convex state. Consequently, an image in which the direction of the shade is converted is generated in order to prevent the improper determination.

Specifically, a geometric conversion processing such as a rotation processing and a mirror-image inversion processing are executed in order to convert the shade direction. However, it should be noted that only the shade direction cannot be changed because the whole image is the processing target in the rotation processing and the inversion processing. Similarly, the acquired circuit pattern and the like are also converted when the rotation/inversion processing are executed. However, this does not cause a problem in the processing in which concavity or convexity is determined by analyzing the shade. This is because, although determination of concavity and convexity is generally determined by using image comparison between a defect image and a reference image, information about the pattern is eliminated at the time of a comparison processing if the same rotation/inversion processing is applied to both of the images, and thus, only shade parts in the site having difference between the defect image and the reference image (that is, defect parts) can be extracted.

Another example of the image processing includes image mixing processing. In FIGS. 3A to 3C, the three images are acquired by separately detecting secondary electrons and backscattered electrons using the imaging device illustrated in FIG. 2. However, it is assumed that different types of devices basically cause difference in the number of detectors and types of detected electrons. Consequently, plural different images are further generated by mixing plural detected images. For example, an imaging device A can acquire images in which an image of secondary electrons and an image of backscattered electrons are completely separated, whereas an imaging device B can detect an image in which the image of secondary electrons and the image of backscattered electrons are mixed, and thereby images resembling the image acquired by the imaging device B can be generated by generating plural images made by mixing each image from the images acquired by the imaging device A in which the image of secondary electrons and the image of backscattered electrons are completely separated and detected.

Types of the image processing described above depend on the number of the images and characteristics of the images required by a classification processing (S705) that is the subsequent stage of the process described below. For example, when an algorithm that assumes the number of the images and the characteristics of each image that are acquired by an imaging device N is used in the classification processing, the other imaging devices use an output image of the imaging device N as the standard and the types of image processing is determined so that the images acquired by the other imaging devices become resembling the standard image, and thereby classification performance can be adequately ensured. Here, the standard image may be arbitrarily selected from the acquired images that are acquired by each imaging device displayed on the screen of the input-output part 108 by the operator, or an optimum image as the standard image may be automatically selected depending on a characteristic amount obtained from each image.

In addition, not a specific imaging device selected from the N imaging devices provided in the defect classification system but a virtual imaging device that is different from any of the N imaging devices (does not exist) can be assumed. In this case, each type of image processing is defined as follows: The number and the type of the images outputted from the virtual imaging device are assumed, and then, types of the classification processing is matched with the output images, and thereafter, all image data sets acquired from the N imaging devices used are converted similar to the output image being the standard of the virtual imaging device. By adequately executing these processings as described above, the defect classification device corresponding to various types of devices as many as possible can be established. An operator can arbitrarily configure various settings such as the number and the types of output images of the virtual imaging device by displaying a setting screen on the screen of the input-output part 108. Various types of image processing exemplified above may not be executed singly but may be executed in combination.

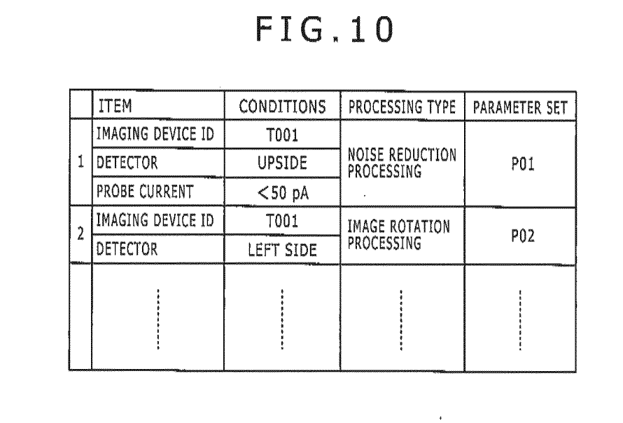

Types of the processing executed based on the associated information corresponding to each image are defined, for example, in the form of a table shown in FIG. 10 and stored in the associated information storage part 111. In each image processing, a processing parameter that determines what types of processing is specifically executed is also stored. FIG. 10 shows an example. For the image that is a top image acquired by the imaging device having a device ID of T001 and is acquired in a condition of a probe current of 50 pA or less, the noise reduction processing is executed in the predetermined parameter set (P01). For the image that is a left image acquired by the imaging device having the device ID of T001, image rotation processing is executed in accordance with the parameter set (P02). The types of processing shown in FIG. 10 need to be newly defined and added in every introduction of a new imaging device. This operation can be performed by receiving an instruction from the operator in the input-output part 108.

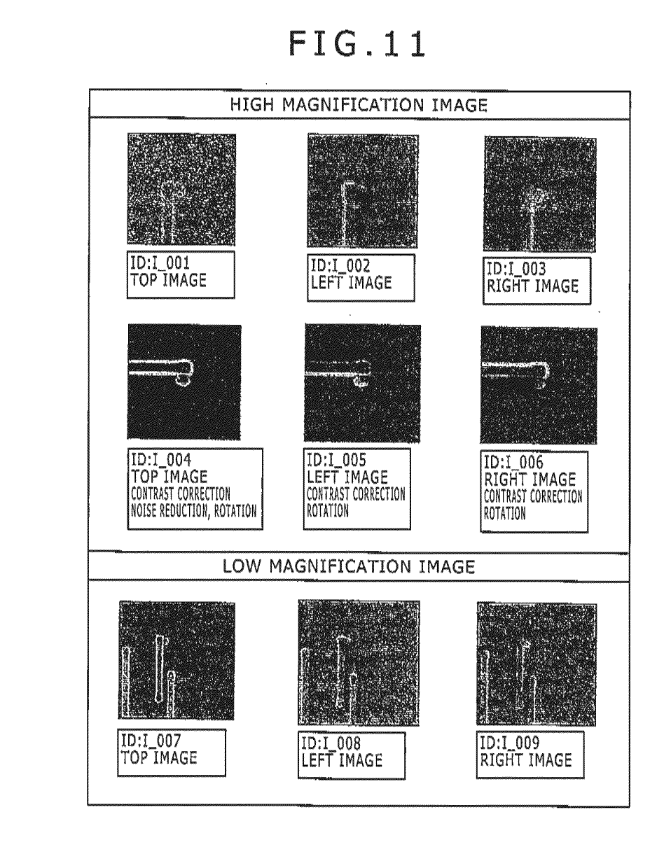

FIG. 11 is a view listing an image data set of a defect (six images in high magnification and low magnification) in a form of a table including the acquired images and images after processing. This is the example in which the noise reduction processing, the contrast correction processing, and the rotation processing are applied to the top image having high magnification and the contrast correction processing and the rotation processing are applied to the right and left images. The operator can check the list of the processed result shown in FIG. 10 by the screen of the input-output part 108. As illustrated in FIG. 11, the screen of the input-output part 108 adequately displays indication indicating whether the image is a top image, a left image, or a right image and the image processing items executed to the images after the image processing, together with the images. Although not illustrated in FIG. 11, the standard image described above may be displayed together with these images.

Description is returned to the flowchart of FIG. 7. Subsequently, the classification processing is executed to the image after the processing by the classification processing part 114. Two processings of a defect characteristic amount extraction processing and a pattern recognition processing are executed as the classification processing. The series of classification processing can be executed by using, for example, a related art disclosed in Japanese Unexamined Patent Application Publication No. 2001-135692. In the defect characteristic amount extraction processing, first, a defect site is recognized from an image data set of each defect, and thereafter, a characteristic amount that is obtained by converting a concave/convex state, a shape, brightness, and the like of the defect into numerical values is calculated. Using the obtained characteristic amount, the pattern recognition processing determines which classification class the defect belongs to. Specifically, the classification class is determined based on the calculated characteristic amount data by refereeing teaching data included in the classification recipe corresponding to the data set that is read in S702. Here, the teaching data is data in which statistical properties of the characteristic amount of each class (statistical information such as average value and standard deviation of the characteristic amount in each classification class) are calculated from the classification characteristic amount calculated from the representative defect image of each classification class previously collected and the calculated properties are stored. Probabilities belonging to each classification class are calculated by comparing the teaching data about each classification class and the calculated characteristic amount and the classification class having the highest probability is determined as the classification result. In the pattern recognition processing, which predetermined classes the defect belongs to may be unclear, when the probabilities of the classification classes are almost equal or when probabilities of any classes are low. Consequently, when the case described above occurs, “unknown class” is determined as the classification result.

After the classification processing is executed to all defect data included in the target data set, the result is transferred to the yield management server 103 (S706). Classification class information of each defect can be sequentially transmitted to the yield management server at the same time as each defect is classified. In addition, the information may be transmitted after the automatic classification result is checked by the operator and necessary correction is performed on the screen of the input-output part 108.

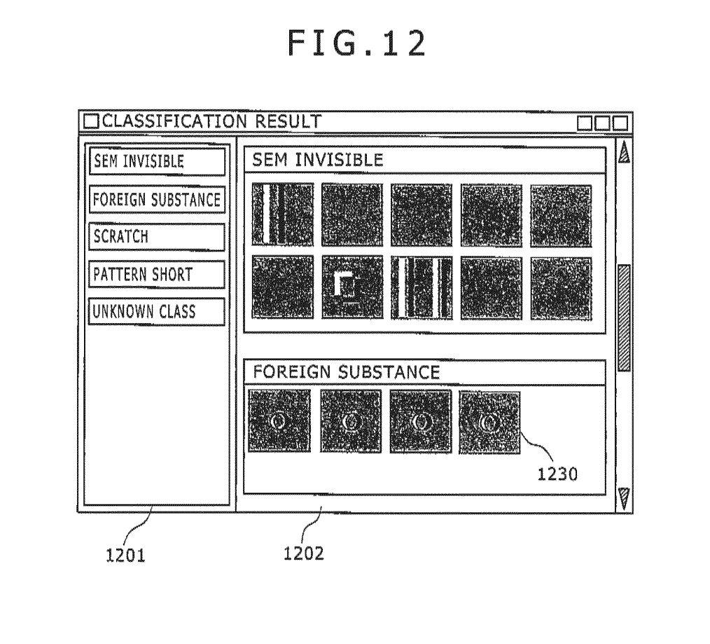

FIG. 12 is an example of the screen on which the classification result to a data set is displayed of the input-output part 108. This display screen is a screen which displays an image list about the defect included in the data set and classification results of each defect. The screen is configured by a classification class display part 1201 and an image display part 1202. In the image display part 1202, images of each defect are arranged and displayed in every classified class. In the image display part 1202, each defect is displayed as images, which are referred to as thumbnails that are iconized by reducing the image size (the thumbnail images 1203). Use of the thumbnail images provides the advantage that many images can be observed in one time. In the classification class display part 1201, when any one of the classes is selected with a mouse or the like, a function in which display position is changed so that the image of the defect classified in the selected class is located in the center of the screen may be provided.

Here, the class being “unknown class” exists in the classification class display part 1201 as described above. The defect data belonging to the unknown class is a defect in which, in the classification processing, which class the defect belongs to cannot be determined. The defect belonging to the unknown class part that a defect class is not provided for the defect yet. The operator can complete the classification processing to all data, if the operator visually checks the image of the defect belonging to the “unknown class” on the screen of the input-output part 108 and provides class names for each data. Specifically, the classification processing can be executed in a manner that the thumbnail of the defect to which the classification class is desired to be added is selected and the selected thumbnail is dragged to the predetermined class name in a classification class display part 802. The previously classified defect data can be corrected by visually checking the classification result of each data on this screen when a misclassification exists, if necessary. Defect data belonging to the “unknown class” may be new defect that users do not expect. Consequently, when the number of defects that is determined as the “unknown class” are many, a new classification class as a new type of defect can be set and the defects may be classified, or the defects may be used as an alarm for starting process analysis by assuming some abnormalities.

### Second Embodiment

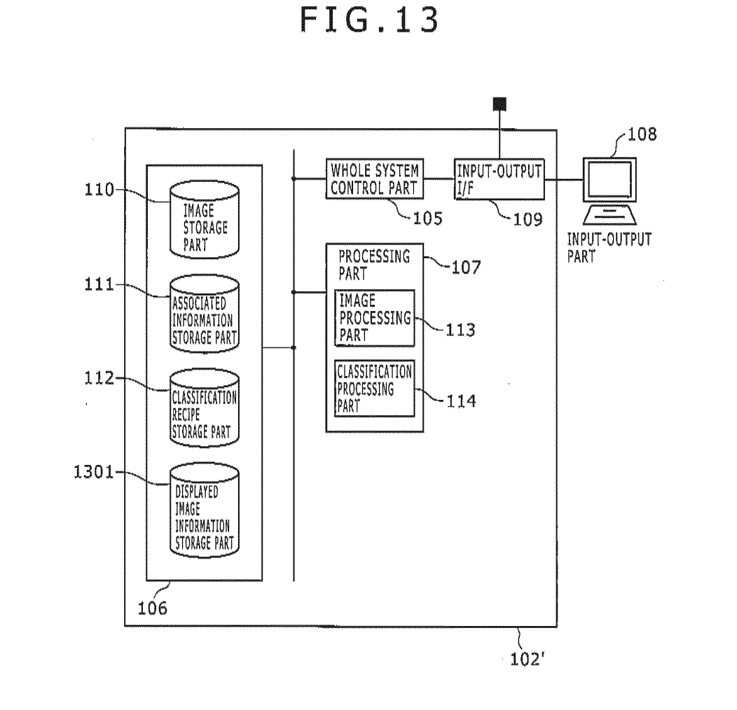

Subsequently, as other embodiment of the defect classification system, a defect classification system having a defect classification device 102′ that is different from the defect classification device in the first embodiment will be described using FIG. 13. The wafer inspection device, the imaging device, and the like connected through the communication part 104 are similar to the first embodiment, and thus, description of a configuration similar to the first embodiment is arbitrarily omitted here and different points are mainly described.

As described above, the display screen illustrated in FIG. 12 displays the image data set as the result of acquisition of plural defects existing in a wafer by the imaging device 101 on the screen of the input-output part 108. Usually, the imaging device 101 acquiring each image may frequently be the same device. In this case, the imaging condition and the characteristics of the detector are not different among the thumbnails each other displayed in an arranged manner.

However, when plural different image sets acquired by the imaging device 101 are alternately checked on the display screen, or when image data acquired by plural imaging devices 101 are checked on the same screen, a sense of discomfort may be provided for the operator at the time of visual check of the images and improper determination of the defect class may occur due to difference in imaging conditions and characteristics of the detectors in each image. For example, as illustrated in the example of FIGS. 6A and 6B, a simultaneous browse of the image acquired by the detectors having different detection direction of backscattered electrons may cause improper recognition that concave/convex states of the images are the same, even when the concave/convex states of the defect site are different. The case that the images acquired by the different imaging devices are checked on the same screen occurs, for example, when a partial data set that is selected by the process name and the imaging date and time is generated from a large amount of the acquired image data sets for the purpose of checking a status and pattern of generated defects for yield management, and the contents are checked on the screen.

Both of a low magnification image having a wide microscopic field and a high magnification image having a narrow microscopic field are acquired for each defect in the ADR processing. Which magnification type of images should be displayed frequently varies depending on the classification result, when plural images having different magnifications for each defect exist. For example, in the high magnification image having the narrow microscopic field, a positional relation between the defect having sufficiently large defect size compared with the microscopic filed region and its background pattern may be easy to be checked in the low magnification image having the wider microscopic field. In addition, the operator may be required to visually check and to determine whether the defects do not really exist or the defects cannot be detected by mistaken image processing for defects, in the case that the defect cannot be detected by the ADC process (in many cases, a class name, for example, “SEM Invisible” or the like is assigned to these defects as defects that cannot be detected with SEM). In this case, the low magnification image having a wide microscopic field is more suitable for the check.

In order to respond this problem, the defect classification device 102′ described in this embodiment has a function that selects an image type at the time of displaying each defect on the screen of the input-output part 108 from the acquired images and images generated as the result of image processing described above, and displays the image type.

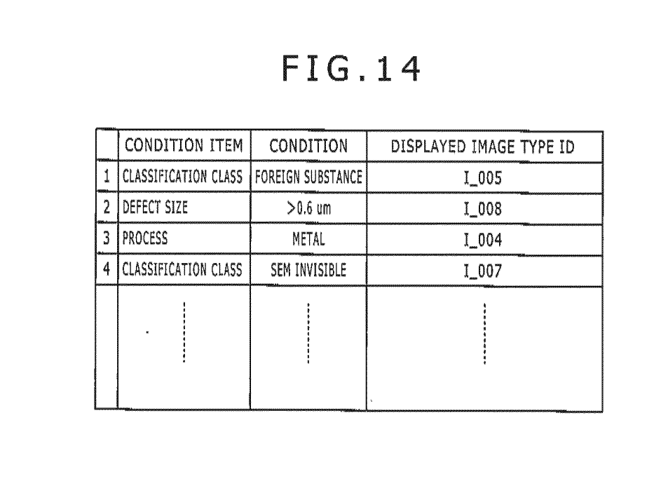

FIG. 13 illustrates a configuration of the defect classification device 102′ according to the second embodiment. In the defect classification device 102′, a displayed image information storage part 1301 is added to the defect classification device 102 illustrated in FIG. 1. Information stored in the displayed image information storage part 1301 is shown in a table in FIG. 14 in a form of a table. Here, an example in which a classification result, a size of a defect, and a process are specified as conditions for selecting the displayed image. For example, when the classification result is a foreign substance having characteristics in that the surface of the foreign substance has a convex shape, a left image or a right image detecting backscattered electrons that are easy to check the concave/convex state is specified to be displayed. When the classification result is “SEM Invisible”, the low magnification image having a wide microscopic field is specified to be displayed. Furthermore, when the size of a defect is larger than a standard, the low magnification image having a wide microscopic field is specified, and when the target process is “Metal” and the defect that is particularly desired to be observed in this process is easy to be checked in the top image, the image is specified. In this table, the displayed image specified by each condition is specified from the list of the acquired images and the image data after processing illustrated in FIG. 11 by using ID added to each image. Even when a defect is matched with plural conditions, the displayed images of the defect can be uniquely determined by defining priority among the plural conditions (for example, it is assumed that 1, 2, 3, and 4 have priorities in this order in the table shown in FIG. 14). The information in the form of a table shown in FIG. 14 can be set and updated at any timing through the screen of the input-output part 108 by the operator.

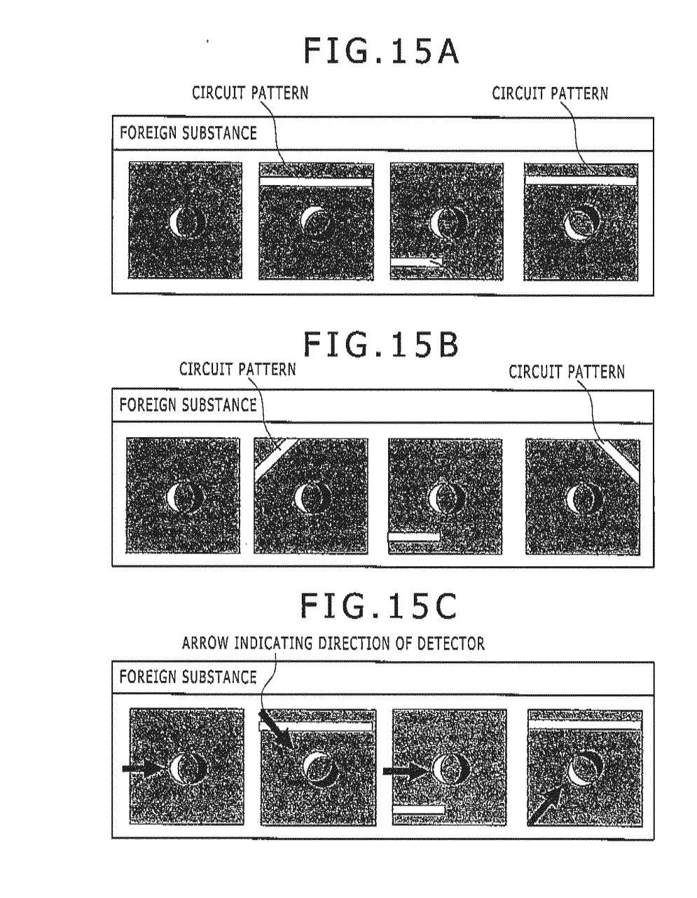

As an example of display on the screen in the input-output part 108, a display screen example when images acquired by plural devices that have different detected shade directions are displayed as thumbnail is illustrated in FIGS. 15A to 15C. This is the example in which four left images that are acquired by detecting backscattered electrons generated from a foreign substance defect are displayed on the screen in the input-output part 108 as the thumbnail images. FIG. 15A is an example in which, although the second image and the fourth image in the four images have different shade direction from the other images, the acquired images themselves are displayed. The images are not adequate for understanding the concave/convex state, because the images have different shade directions. On the other hand, FIG. 15B is a display screen in which the shade directions of each defect are unified by displaying the images after the rotation processing is executed so as to have the same directions in the image processing. When the images having the same shade direction are displayed, whether the classification result of each defect is correct or not; in this example, whether the defect is the “foreign substance” having characteristics that is convex or not is easy to be checked. It should be noted that, when the rotation processing or the mirror-image inversion processing is executed in order to unify the shade directions, the pattern directions of the acquired images are also rotated or inverted at the same time.

Requirement of a check for both of the images before and after the image processing can be solved in a manner that, for example, a scheme that switches display of FIGS. 15A and 15B is provided on the screen in the input-output part 108 and a function that switches the images in a short period in accordance with instructions from the operator is provided for an operation in which both of the pattern direction in the image before image processing and the concave/convex state of the defect are visually observed. When the operator performs visual operation, the operator issues an instruction of switching the display screen at any timing and the displayed screen is converted in accordance with the instruction in real time. As a result, the operator can operate the visual check in high efficiency.

In order to achieve the purpose that the operator can easily perform the visual check, a method for displaying the image data and the associated information itself corresponding to the image data at the same time and a method for displaying the image data and information generated based on the associated information corresponding to the image data at the same time, except the method for displaying the images after the image processing as described above, can be considered. For example, as illustrated in FIG. 15C, the direction of a detector may be displayed as an arrow symbol when the images having different detection direction of backscattered electrons are displayed. It is considered that the display in the form of easy to visually check the direction is also effective for the operation for determining the concave/convex state of the defect.

### Third Embodiment

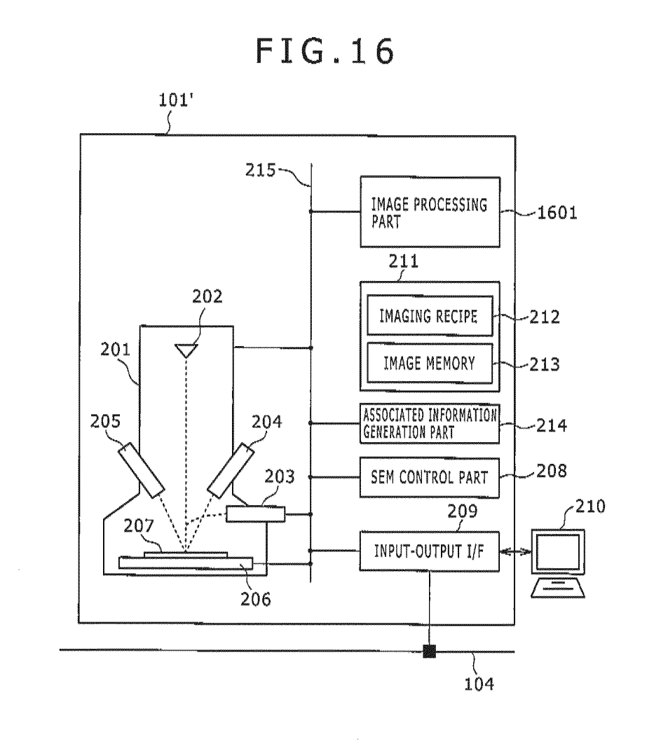

Subsequently, as another example of the defect classification system, a defect classification system in which a part where the image processing is executed used for the classification processing and display provided at the location different from the first embodiment and the second embodiment will be described using FIG. 16. The wafer inspection device, the imaging device, and the like connected through the communication part 104 are similar to the first embodiment and the second embodiment, and thus, description of a configuration similar to the first embodiment is arbitrarily

In the defect classification systems according to the first embodiment and the second embodiment, the image processing is executed by the image processing part 113 located in the processing part 107 of the defect classification device 102, 102′. However, the image processing part is not necessarily located in the defect classification device 102, 102′. For example, as illustrated in FIG. 16, the image processing part 1601 may be located in the imaging device 101′. The image processing part 1601 executes image processing depending on characteristics and the number of the detectors that each imaging device 101′ has at the time of the classification processing in the defect classification device 102, 102′ in order to execute the processing without considering the types of the devices that acquire the images. As shown in FIG. 10, the types of the image processings executed in each imaging device 101′ is associated with ID of the imaging device 101′, or information of the detector and the imaging conditions, and stored as the imaging recipe storage part 212 in the imaging device 101′. The operator can check and update this information through the screen of the input-output part 210.

According to the defect classification system according to the third embodiment, calculation load that is required for the image processing can be distributed. As described in the first embodiment and the second embodiment, when the image processing for whole images are executed in the defect classification device 102, 102′, the load may become large and throughput of the classification processing may be reduced when the number of the acquired images becomes large. If this image processing is executed in each imaging device 101′, the calculation load in the defect classification device 102, 102′ can be reduced. In order to achieve this purpose, the image processing part 1601 may be included in other devices other than the imaging device 101′ and the defect classification device 102, 102′. For example, another device dedicated for image processing is provided; data is inputted from the imaging devices 101 through the communication part 104; and the predetermined image processing is executed, and thereafter, the processed result or a set of the processed result and the input image may be transmitted to the defect classification device 102. It goes without saying that a similar effect can also be obtained by separating the image processing into plural processings, and distributedly executing in the imaging device, the defect classification device, or the device dedicated for image processing.

As described above, the invention achieved by the inventors of the present invention is specifically described based on the embodiments. However, the present invention is not limited to the embodiments described above, and various changes may be made without departing from the scope of the invention. For example, the embodiments described above is described in detail in order to describe the present invention in an easy to understand way, and the present invention is not always limited to the invention that includes every constitution described above. A part of the constitution in certain embodiment can be replaced with the constitution in other embodiments, and the constitution in other embodiments can be added to the constitution in certain embodiment. Other constitution can be added to, deleted from, and replaced with a part of the constitution in each embodiment.

What is claimed is:

1. A defect classification device that classifies a plurality of images of a defect on a sample surface that is an inspection target acquired by a plurality of imaging devices, the defect classification device comprising:
an image storage part that stores a plurality of images acquired by the plurality of imaging devices;
an associated information storage part that stores associated information associated with each of the plurality of images, the associated information comprising at least one of information that specifies a type of the plurality of imaging devices that acquire each of the plurality of images or information of detection conditions at the time of acquiring the plurality of images;
an image processing part that processes a part of or the all of the plurality of images so that the plurality of images resemble each other based on the associated information stored in the associated information storage part; and
a classification part that classifies the plurality of images based on the plurality of images processed by the image processing part.

2. The defect calcification device according to claim 1,
further comprising a display part that displays a classification result classified by the classification part,
wherein the display part displays processing contents processed to the processed images together with the processed images when the processed images processed by the image processing part are displayed.

3. The defect calcification device according to claim 1,
further comprising a display part that displays a classification result classified by the classification part,
wherein the display part displays the associated information.

4. The defect calcification device according to claim 1,
wherein the information of the detection conditions of the associated information associated with each of the plurality of images comprises at least one of information that specifies a type of detectors of the plurality of imaging devices that are used for acquiring each of the plurality of images or information of imaging conditions at the time of acquiring the plurality of images.

5. The defect calcification device according to claim 1,
wherein, the image processing part acquires a plurality of images that resemble each other by generating one or more new images based on the plurality of images.

6. The defect calcification device according to claim 1,
wherein the image processing part executes any one or more of a rotation processing or a mirror-image inversion processing of an image, or an image quality improvement processing.

7. An imaging device that acquires an image of a defect on a sample surface that is an inspection target, the device comprising:
an electron beam irradiation part that irradiates a sample surface with an electron beam based on previously obtained defect position information;
an imaging part that acquires a plurality of images in a manner that secondary electrons or backscattered electrons generated from the sample surface by irradiation with an electron beam by the electron beam irradiation part are detected by a plurality of detectors;
an associated information generation part that generates associated information associated with each of the plurality of images and having information of detection conditions at the time of acquiring the plurality of images; and
an image processing part that processes a part of or the all of the plurality of images so that the plurality of images resemble each other based on the associated information generated by the associated information generation part.

8. A defect classification system comprising:
a plurality of imaging devices that acquire images of a defect on a sample surface that is an inspection target;
a defect classification device including an image storage part that stores a plurality of images acquired by the plurality of imaging devices, an associated information storage part that stores associated information associated with each of the plurality of images, the associated information including at least one of information that specifies a type of the plurality of imaging devices that acquire each of the plurality of images or information of detection conditions at the time of acquiring the plurality of images; and
an image processing part that processes a part of or the all of the plurality of images so that the plurality of images resemble each other based on the associated information stored in the associated information storage part,
wherein the defect classification device further comprises a classification processing part that classifies the plurality of images based on the plurality of images processed by the image processing part.

9. The defect classification system according to claim 8,
wherein the image processing part is included in the defect calcification device.

10. The defect classification system according to claim 9,
wherein the defect calcification device further comprises a display part that displays a classification result obtained by the classification processing part, and the display part displays processing contents processed to the processed images together with the processed images when the processed images processed by the image processing part are displayed.

11. The defect classification system according to claim 9,
wherein the defect calcification device further comprise a display part that displays a classification result classified by the classification part, and
wherein the display part displays the associated information.

12. The defect classification system according to claim 9,
wherein the information of the detection conditions of the associated information associated with each of the plurality of images comprises at least one of information that specifies a type of detectors of the plurality of imaging devices that are used for acquiring each of the plurality of images or information of imaging conditions at the time of acquiring the plurality of images.

13. The defect classification system according to claim 9,
wherein the image processing part acquires a plurality of images that resemble each other by generating one or more new images based on the plurality of images.

14. The defect classification system according to claim 9,
wherein, the image processing part executes any one or more of a rotation processing or a mirror-image inversion processing of an image, or an image quality improvement processing.

15. The defect classification system according to claim 8,
wherein the image processing part is included in each of the plurality of imaging part.

16. The defect classification system according to claim 8, further comprising:
an inspection device that is connected to the plurality of imaging devices and the defect classification device through a communication part and that detects the defect on the sample surface which is the inspection target.
